(19) United States
(12) Patent Application Publication
(10) Pub. No.: US 2022/0005122 A1
(43) Pub. Date: Jan. 6, 2022

(54) COMPUTER-IMPLEMENTED METHOD OF MANAGING AN INSURANCE CLAIM

(71) Applicant: PETSURE (AUSTRALIA) PTY LTD, Chatswood, New South Wales (AU)

(72) Inventors: Toby Yoo, Chatswood, New South Wales (AU); Geoffrey Nigel Mathers, Chatswood, New South Wales (AU)

(21) Appl. No.: 17/280,696

(22) PCT Filed: Sep. 27, 2019
(86) PCT No.: PCT/AU2019/051045

§ 371 Date: Mar. 26, 2021

(30) Foreign Application Priority Data
Sep. 28, 2018 (AU) 2018903667

(51) Int. Cl. G06Q 40/08; G06Q 10/10

(52) U.S. Cl. CPC G06Q 40/08; G06Q 50/22; G06Q 10/10

(57) ABSTRACT

The present invention is directed to a computer-implemented method of managing an insurance claim which performs the steps of: 1. receiving claim data associated with an insurance claim made under an insurance policy of an insurance provider, the insurance claim being made in respect of treatment of an animal at a veterinary practice; 2. processing the claim data to provide a claim workflow derived from the claim data; 3. electronically submitting an integrated claim workflow to the insurance provider for assessment of the insurance claim under the insurance policy; 4. receiving notification from the insurance provider of a benefit amount to be paid by the insurance provider under the insurance policy for the treatment; 5. electronically informing the veterinary practice of the benefit amount to be paid by the insurance provider to either the veterinary practice or a policy owner of the insurance policy.

### TECHNICAL FIELD

The present invention relates broadly to a computer-implemented method of managing an insurance claim for treatment of an animal. The invention is also broadly directed to a computer system for managing an animal insurance claim.

### BACKGROUND

Trupanion Inc. in their US patent publication no. 2017/0039329 describe a pet insurance system and method. More particularly, Trupanion describe an architecture where they supply an “agent” (computer program) which is capable of interacting with the software at a veterinary practice. The veterinary practice submits an insurance claim for a pet treatment on behalf of the pet owner or other customer from a client/browser application or website referred to as “Trupanion Express”. The Trupanion Express” website uses the “agent” program and data entered by the veterinary practice to submit the insurance claim to Trupanion servers. The veterinary practice enters the relevant data for the pet treatment via the Trupanion website. The exchange of information between the veterinary practice and Trupanion is in a proprietary data format. Trupanion quickly adjudicates the insurance claim and, on approval of the claim, Trupanion directly pays the veterinary practice for the treatment in near real time. The pet owner then pays for their portion of the treatment to the veterinary practice and Trupanion are notified of this payment via the “Trupanion Express” website.

### SUMMARY OF INVENTION

According to a first aspect of the present invention there is provided a computer-implemented method of managing an insurance claim, said method comprising the steps of:

receiving claim data associated with an insurance claim made under an insurance policy of an insurance provider, said insurance claim being made in respect of treatment of an animal at a veterinary practice;

processing the claim data to provide a claim workflow derived from said claim data;

electronically submitting an integrated claim workflow to the insurance provider for assessment of the insurance claim under the insurance policy, the integrated claim workflow being derived from the claim workflow and provided in a format compatible for submission to the insurance provider;

receiving notification from the insurance provider of a benefit amount to be paid by the insurance provider under the insurance policy for said treatment;

electronically informing the veterinary practice of the benefit amount to be paid by the insurance provider to either the veterinary practice or a policy holder of the insurance policy.

Preferably the method also comprises the step of receiving notification of payment of a remaining amount from the policy holder or an associated individual to the veterinary practice for the treatment of the animal, the remaining amount calculated by deducting the benefit amount from an invoiced amount for said treatment. More preferably the notification of payment of the remaining amount is transmitted to the insurance provider prompting payment by the insurance provider of the benefit amount to the veterinary practice or the policy owner. Still more preferably the remaining amount is paid at the veterinary practice the policy owner or the associated individual at the time of attending the veterinary practice for the treatment.

Preferably the method further comprises the step of reading the claim data to identify an insurance claim as a benefit claim where the veterinary practice has categorised the insurance claim as potentially being eligible for payment of a benefit amount by the insurance provider. More preferably, in the event the insurance claim is identified as a benefit claim, the method further comprises the step of prompting the insurance provider to assess the insurance claim following its receipt and processing. Even more preferably said prompting involves automatically sending a telecommunication alert to the insurance provider notifying them of the receipt of the insurance claim and in anticipation of submission of the integrated claim workflow associated with the insurance claim.

Preferably the step of receiving notification of the benefit amount from the insurance provider involves electronically querying the insurance provider in relation to a benefit amount being payable for the treatment of the animal at the veterinary practice. More preferably said step of querying the insurance provider involves periodic polling of the insurance provider in relation to the benefit amount. Even more preferably in the event of a change in the status of the insurance claim, the step of receiving notification of the benefit amount also involves the insurance provider responding to the periodic polling with notification of the benefit amount.

Preferably the method also comprises the step of storing the notification of the benefit amount received from the insurance provider in an insurance integration database from which the integrated claim workflow is electronically submitted. More preferably the notification of the benefit amount is entered into the insurance integration database for storage via an associated insurance user interface.

Preferably the method still further comprises the step of sending the notification of the benefit amount from the insurance integration database to a claim workflow database associated with the claim workflow. More preferably the notification of the benefit amount is converted to a compatible data format capable of being read by the veterinary practice. Still more preferably the compatible data format is based on a canonical data model. Even still more preferably the notification of the benefit amount in the compatible data format is stored in the claim workflow database.

Preferably the step of electronically informing the veterinary practice of the benefit amount involves prompted delivery of the notification of the benefit amount to the veterinary practice in the compatible data format in response to periodic polling from the veterinary practice. Alternatively the benefit amount in the compatible data format is delivered to the veterinary practice by calling the veterinary practice for pushing of the benefit amount to said practice.

According to a second aspect of the invention there is provided a computer system for managing an animal insurance claim, said system comprising:

a storage component including a claim workflow database for storing a claim workflow derived from claim data associated with an insurance claim for treatment of an animal;

a submitting component arranged to communicate with the storage component, said submitting component being configured to electronically submit an integrated claim workflow to an insurance provider for assessment of the insurance claim under an insurance policy pertaining to the animal, the integrated claim workflow being derived from the claim workflow and provided in a format compatible for submission to the insurance provider;

a notification component configured to receive a notification from the insurance provider of a benefit amount to be paid by the insurance provider under the insurance policy for said treatment;

an informing component arranged to communicate with the notification component, said informing component being configured to electronically inform the veterinary practice of the benefit amount to be paid by the insurance provider to either the veterinary practice or a policy owner of the insurance policy.

According to a third aspect of the invention there is provided a computer system for managing an animal insurance claim, said system comprising:

a processor;

a memory device which stores a plurality of instructions which when executed by the processor cause the processor to:
receive claim data associated with an insurance claim made under an insurance policy of an insurance provider, said insurance claim being made in respect of treatment of an animal at a veterinary practice;
process the claim data to provide a claim workflow derived from said claim data;
electronically submit an integrated claim workflow to the insurance provider for assessment of the insurance claim under the insurance policy, the integrated claim workflow being derived from the claim workflow and provided in a format compatible for submission to the insurance provider;
receive notification from the insurance provider of a benefit amount to be paid by the insurance provider under the insurance policy for said treatment;
electronically inform the veterinary practice of the benefit amount to be paid by the insurance provider to either the veterinary practice or a policy owner of the insurance policy.

### BRIEF DESCRIPTION OF DRAWINGS

In order to achieve a better understanding of the nature of the present invention a preferred embodiment of a computer-implemented method of managing an insurance claim for treatment of animal will now be described, by way of example only, with reference to the accompanying illustrations in which:

FIG. 1 is a schematic flow diagram showing data flow between the various components of a computer system including a software platform for managing an animal insurance claim according to one aspect of the invention;

FIG. 2 is a schematic flow diagram of a method of managing an insurance claim according to another aspect of the invention illustrating implementation of part of the method via the software platform of FIG. 1 built in a microservice architecture;

FIG. 3 is a schematic flow diagram of the remainder of the method of the embodiment of FIG. 2 showing implementation of this aspect of the invention via the software platform of FIG. 2;

FIGS. 4A to 4C are schematic block diagrams depicting workflows and data flow from the computer system and the method of the preceding figures.

### DETAILED DESCRIPTION

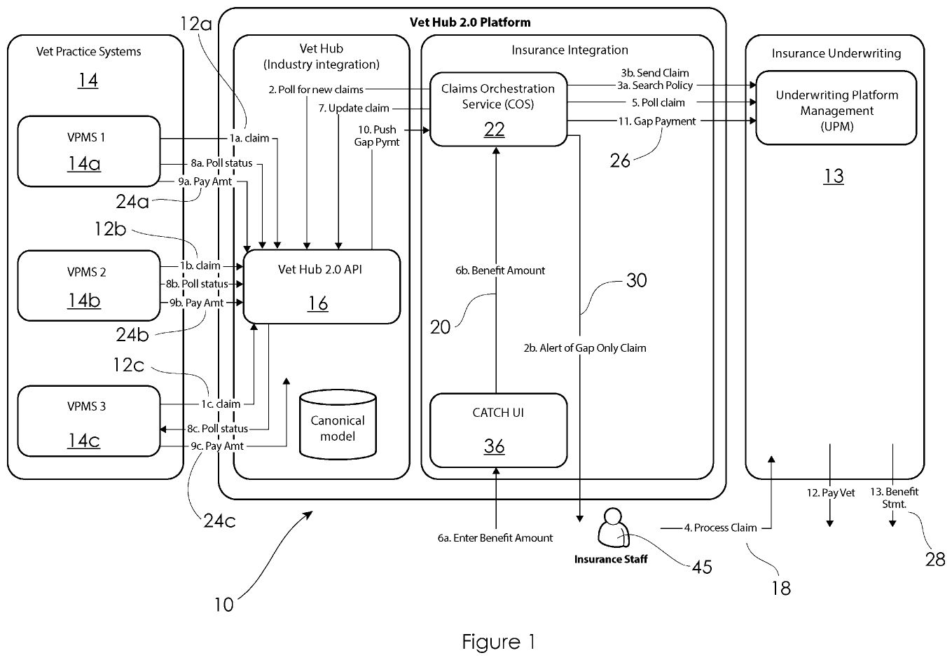

As best seen in FIG. 1, there is a computer-implemented method of managing an insurance claim according to one aspect of the invention. The method of this embodiment is enabled via a computer system and an associated software platform 10 which broadly performs the steps of:
1. receiving claim data at 12a to 12c associated with an insurance claim made under an insurance policy of an insurance provider 13, the insurance claim being made in respect of treatment of an animal at a veterinary practice 14;
2. processing the claim data at 16 to provide a claim workflow derived from the claim data such as 12a;
3. electronically submitting an integrated claim workflow to the insurance provider 13 for assessment of the insurance claim at 18 under the insurance policy;
4. receiving notification at 20 from the insurance provider 13 of a benefit amount to be paid by the insurance provider 13 under the insurance policy for the treatment;
5. electronically informing the veterinary practice 14 of the benefit amount to be paid by the insurance provider 13 to either the veterinary practice 14 or a policy owner of the insurance policy.

In this embodiment the integrated claim workflow is derived from the claim workflow and provided in a format compatible for submission to the insurance provider 13. The integrated claim workflow is constructed at the claims orchestration service (COS) at 22. The COS 22 is modular in the sense that it is tailored to align the integrated claim workflow and associated data with the insurance provider or more particularly the underwriting platform to the UPM 13 by translating the claim workflow of the associated application program interface (API) into an integrated claim workflow which is compatible with the selected UPM 13. This means the veterinary practice 14 in making an insurance claim can rely upon their own software and associated user interface to communicate directly with the UPM 13.

In this example the method also comprises the step of receiving notification of payment of a remaining or gap amount at 24a to 24c made by a policy owner or an associated individual at the time of attending the veterinary practice 14 for the treatment. It will be understood that the remaining amount which is colloquially referred to as the gap is calculated by deducting the benefit amount to be paid by the insurance provider from an invoiced amount for the treatment by the veterinary practice 14. In this case the notification of payment of the gap is transmitted to the insurance provider at 26 prompting payment by the insurance provider 13 of the benefit amount at 28 to the veterinary practice 14. If the policy owner elects to pay the invoiced amount in full then the payment of the benefit amount is made to the policy owner and not the veterinary practice. In either case it is expected that the benefit amount will be reimbursed by the insurance provider within around 48 hours. The insurance provider 13 is notified of payment of the gap by the policy owner or associated individual via the VPMS 14. The reimbursement by the insurance provider 13 is only triggered via communication from the VPMS 14 in the event that the gap amount is paid in full to the veterinary practice.

If the policy owner for whatever reason pays in excess of the remaining or gap payment, the method via the software platform 10 implements the following steps:
1. the excess payment is assessed at the UPM 13 and deducted from the benefit amount to otherwise be reimbursed to the veterinary practice 14;
2. the UPM 13 repays the policy holder the excess payment.

Although not fully illustrated, the method further comprises the step of reading the claim data to identify or flag the insurance claim as a benefit claim where the veterinary practice is potentially eligible for receipt of a benefit amount paid by the insurance provider. This may be effected by the veterinary practice categorising or flagging the insurance claim as a claim for which the policy owner may have elected to pay the gap only. In the event the insurance claim is identified as a benefit or gap only claim, the method further comprises the step of prompting the insurance provider to promptly assess the insurance claim following its receipt and processing. In this embodiment the insurance provider or staff is prompted at 30 by a telecommunication alert notifying them of the receipt of the insurance claim and in anticipation of electronic submission of the integrated claim workflow associated with the insurance claim.

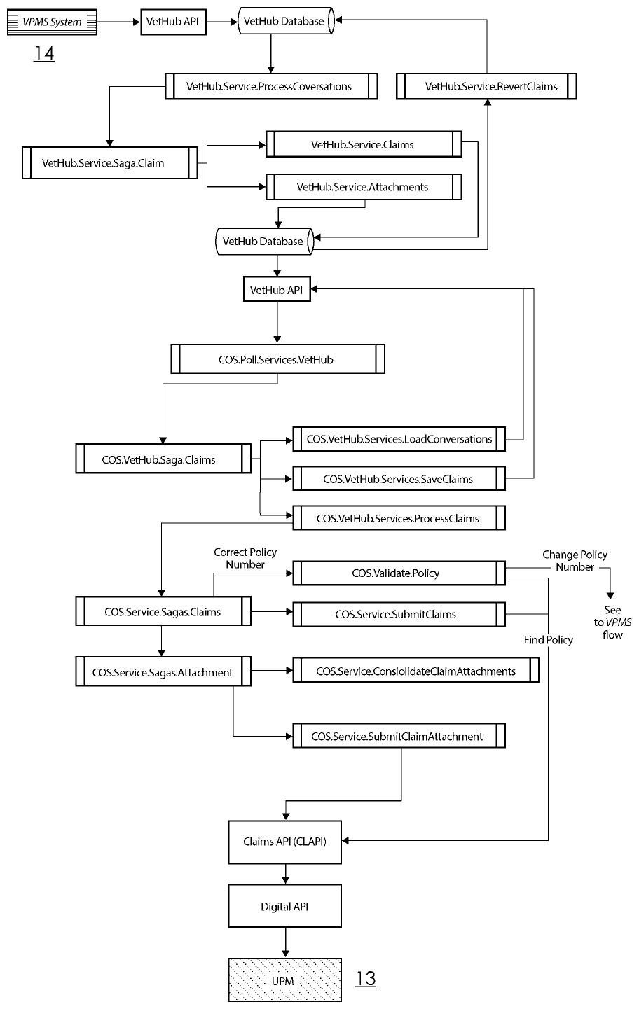

FIG. 2 illustrates in more detail part of the software platform of this embodiment of the invention built in the microservice architecture. Implementation of the preferred methodology uses the Saga pattern to manage workflows within the illustrated software platform. The microservices of this embodiment and of relevance to FIG. 2 are listed below:

| | Type | |
|---|---|---|
| | Windows/ | |
| Service Name | NServiceBus | Description |
| VetHub.Service.ProcessCoversations | Windows | Service to read all new conversations submitted to |
| | | VetHub API and push them to VetHub Saga. |
| VetHub.Service.Saga.Claim | NServiceBus | Saga for VetHub inbound claims workflow. |
| VetHub.Service.Claims | NServiceBus | Service to process conversations and mark them |
| | | ready for download |
| VetHub.Service.Attachments | NServiceBus | Generates attachments for RxWorks claims |
| VetHub.Service.RevertClaims | NServiceBus | Re-process failed conversations. |
| COS.Poll.Services.VetHub | Windows | Poll for conversation which are ready to download |
| | | and push them to COS.VetHub.Saga.Claims queue |
| COS.VetHub.Saga.Claims | NServiceBus | Saga for COS inbound claims workflow from |
| | | VetHub. |
| COS.VetHub.Services.LoadConversations | NServiceBus | Service to load all conversations to COS VetHub |
| | | Conversation table |
| COS.VetHub.Services.SaveClaims | NServiceBus | Downloads Claim and Attachments from VetHub |
| COS.VetHub.Services.Processclaims | NServiceBus | Prepares claim object and submits to COS Claim |
| | | Saga |
| COS.Service.Sagas.Claims | NServiceBus | Saga for COS inbound claims workflow into |
| | | Insurance system via Claims API. |
| COS.Service.ValidatePolicy | NServiceBus | Validate Policy number against Insurance records. |
| COS.Service.SubmitClaims | NServiceBus | Submit claim to Insurance system. |
| COS.Service.Sagas.Attachment | NServiceBus | Saga for managing attachments into insurance |
| | | system. |
| COS.Service.ConsolidateClaimAttachments | NServiceBus | Consolidate all attachments into single PDF |
| | | attachment. |
| COS.Service.SubmitClaimAttachment | NServiceBus | Submit claim attachment to insurance system. |

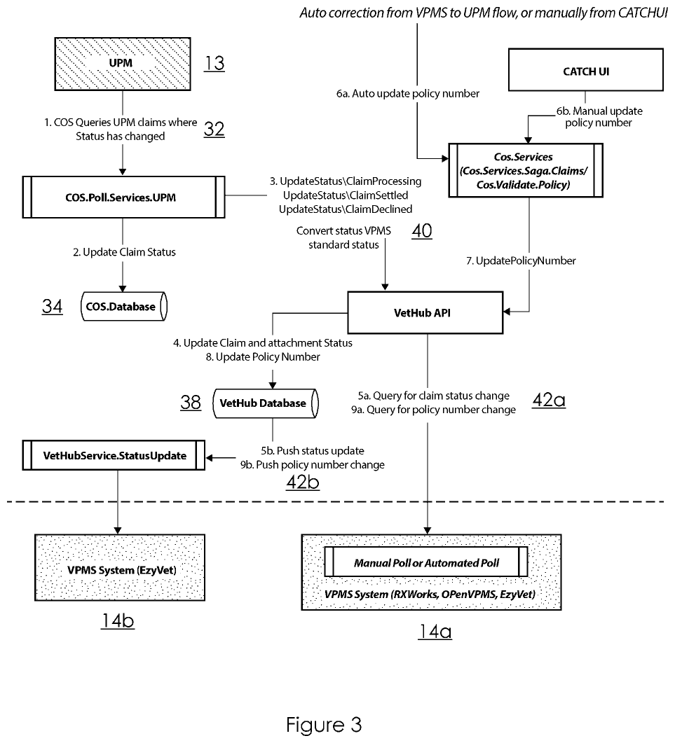

FIG. 3 illustrates remainder of the software platform dedicated largely to functionality associated with updating the status of the insurance claim and extracting the associated benefit amount.

In this example the step of receiving notification of the benefit amount from the insurance provider 13 involves electronically querying the insurance provider 13 in relation to a benefit amount being payable for the treatment of the animal at the veterinary practice such as 14a or 14b. The insurance provider or underwriting platform management (UPM) 13 is periodically polled in relation to the benefit amount. In the event of a change in the status of the insurance claim, the UPM at 32 responds to the periodic polling with notification of an updated status including the benefit amount.

In this embodiment the method also comprises the step of storing the notification of the benefit amount received from the insurance provider or UPM 13 in an insurance integration database at 34. The benefit amount may be entered into the insurance integration database 34 for storage via an associated insurance user interface at 36 (see FIG. 1).

Returning to FIG. 3, the method still further comprises the step of sending the notification of the benefit amount to a claim workflow database at 38. The notification of the benefit amount is in this example converted to a compatible data format at 40 capable of being read by the veterinary practice 14a/b. In this case the compatible data format is based on a canonical data model consistent with claim data received from the veterinary practice, or the veterinary practice management system (VPMS) 14a/b. The compatible data format is typically an industry standard data format such as VetXML.

In this embodiment the step of electronically informing the veterinary practice 14a/b of the benefit amount involves prompted delivery of the benefit amount at either 42a or 42b to the veterinary practice in the compatible data format. This prompted delivery of the updated status including the benefit amount is either i) in response to periodic polling at 42a from the veterinary practice 14a or ii) resulting from periodic pushing at 42b of the benefit amount to the veterinary practice 14b. The benefit amount is thus reported to the veterinary practice in substantially real time. This allows the policy owner or associated individual to attend to payment of the remaining or gap amount at the time of attending the veterinary practice for the treatment. It is expected that substantially real time reporting of the benefit amount to the veterinary practice and their determination of the remaining or gap payment (based on the invoiced amount) will be effected in less than around 10 minutes meaning the policy owner/customer is not waiting an extended period to settle their invoice.

In the event the insurance claim is declined by the UPM 13 this is communication together with notification of an updated status to VPMS 14a/b. The veterinary practice will then be required to collect the full invoiced amount from the policy holder/customer. The VPM13 will not make any benefit amount payments to either the customer or the veterinary practice. If the insurance claim for whatever reason cannot be processed by the software platform 10 or the UPM 13, the veterinary practice will be notified of this failure either by telephone from insurance staff or via the VPMS 14a/b, possibly in conjunction with notification of an updated status from the UPM 13. Once again the veterinary practice will then be required to collect the full invoiced amount from the policy holder/customer.

The microservices of this embodiment and of relevance to FIG. 3 are listed below:

| | Type | |
|---|---|---|
| | Windows/ | |
| Service Name | NServiceBus | Description |
| COS.Poll.Services.VetHub | Windows | Poll for conversation which are ready to download |
| | | and push them to COS.VetHub.Saga.Claims queue |
| COS.Poll.Services.UPM | Windows | Periodic poll query to UPM insurance system for |
| | | status changes. |

As best seen in FIG. 1, it is to be understood that the insurance provider of the invention in the context of the preferred embodiment includes the insurance underwriter together with the associated UPM 13, the insurance user interface (UI) 36 and the insurance staff 45 for claims assessment and management. The claim workflow of the invention in the context of the preferred embodiment includes the API components 16 and the associated claim workflow database 38. The integrated claim workflow of the invention in the context of the preferred embodiment includes the COS 22 and the associated insurance integration database 34.

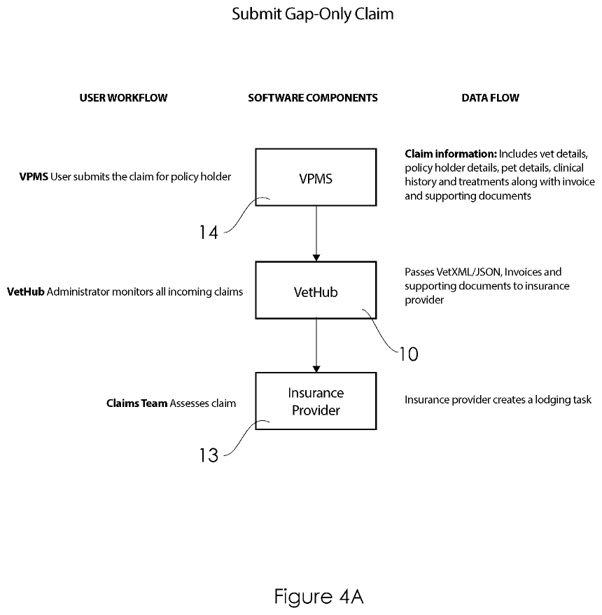

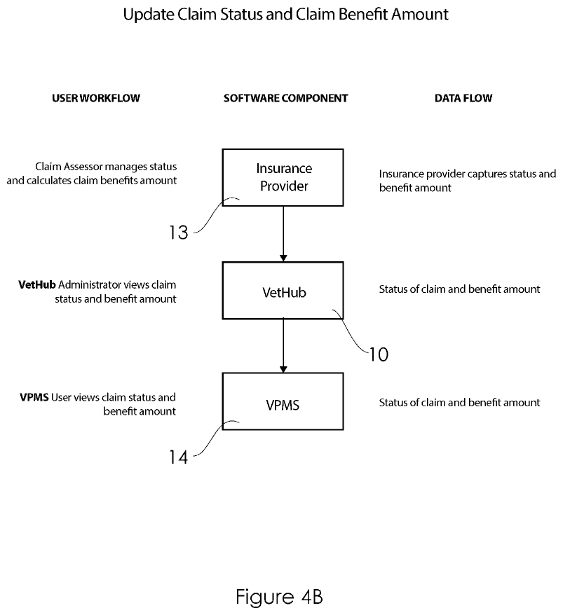

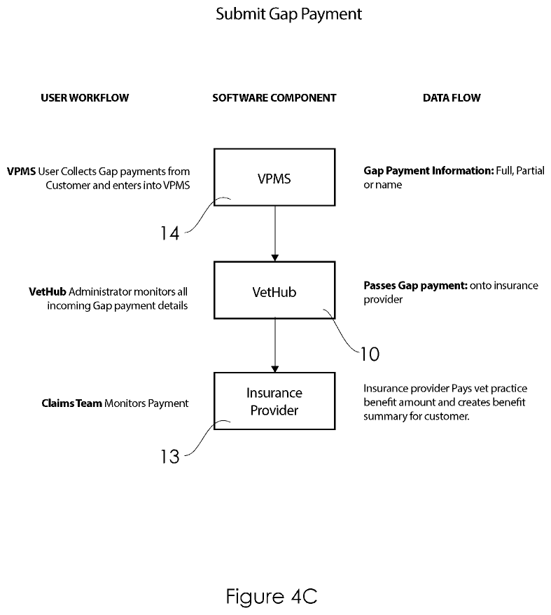

FIGS. 4A to 4C are high level illustrations of the software components relevant to the computer system of another aspect of the invention for managing an animal insurance claim. In this example and as seen in FIG. 4A, the relevant workflows in submission of the insurance claim are as follows:
1. staff at the veterinary practice 14 submit an insurance claim under an insurance policy for treatment of an animal at the veterinary practice 14;
2. the software platform 10 receives and processes claim data associated with the insurance claim;
3. the insurance provider 13 assesses the insurance claim under the insurance policy for which the treatment of the animal is provided at the veterinary practice 14.

This illustration also details examples of user workflows and data flow in the course of submission and processing of the claim. It will be appreciated that the specific information and data type may vary from the examples listed and still remain within the scope of the invention.

FIG. 4B illustrates workflows associated with changes in the status of the insurance claim and more particularly notification of the benefit amount where:
1. a claims assessor at the insurance provider 13 updates the status of the insurance claim, for example “processing” “failed processing” “settled” or “declined”, and if relevant their assessment of the benefit amount to be paid by the insurance provider 13;
2. the software platform 10 receives notification of the benefit amount under the insurance policy for the treatment;
3. the veterinary practice or the VPMS 14 is informed of the benefit amount, typically to be paid by the insurance provider 13 to the veterinary practice 14.

FIG. 4C illustrates workflows associated with submission of the remaining or gap payment made by the policy holder or the associated individual where:
1. staff at the veterinary practice receive the remaining or gap payment from the customer and enter it into the VPMS 14;
2. the software platform 10 receives notification of the gap payment under the insurance policy for the treatment;
3. the insurance provider 13 is informed of the gap payment triggering payment of the benefit amount and prompting dispatch of a benefit summary to the policy holder.

It will be understood that the methodology adopted by the software platform 10 of the preceding aspect of the invention is enabled by the various components of the computer system of this aspect for managing animal insurance claims. These components may be in the form of either software or hardware associated with the software platform 10.

FIG. 1 depicts the specific steps involved in managing an insurance claim in the form of the gap only claim for payment of a benefit amount by the insurance provider. It will be appreciated that the particular order and detail for each of the steps may vary whilst remaining within the broad scope of the invention. Following the numbering of the annotated steps in the flow diagram, the method in this embodiment functions as follows:

1 a. to 1 c. VPMS calls a vet hub API of the platform to submit the claim in an industry standard canonical model. Vet hub stores the claim, and all attachments in the canonical model format at a claim workflow database.
2. COS polls the vet hub API to query for new claims submitted, and retrieves them to COS from the claim workflow database.
2b. COS sends a notification (phone call) to insurance staff to alert the insurance provider of the gap only claim.
3a. COS validates the policy number of the claim against corresponding UPM data, and corrects an invalid policy number using other fields (name, address, etc).
3b. COS submits the claim to the UPM under a high priority queue.
4. Insurance staff process the claim from the high priority queue.
5. COS periodically polls the UPM to see if the claim status has changed, and if so, the updated status including the benefit amount is retrieved from the UPM and automatically saved into COS.
6a & 6b. Alternatively, once the UPM calculates the benefit amount, the benefit amount is entered into an insurance provider UI and saved into COS.
7. COS sends the updated status and benefit amount to the vet hub API, which is saved in the canonical model format in the claim workflow database.
8a & 8b. VPMS periodically polls the vet hub API querying for claim status changes and benefit amount and/or policy number changes. If changed, it will update the status and communicate the benefit amount to the veterinary practice or VPMS.
8c. Alternatively, the vet hub API will call VPMS to push claim status changes and the benefit amount and/or policy number changes to it. If changed, it will update the status and communicate the benefit amount to the vet practice or VPMS.
9a. to 9c. The veterinary practice advises the policy owner or customer of the benefit amount and the gap. The customer pays the gap only, and that value is sent back to the vet hub API.
10. The vet hub API pushes any new gap payments to COS.
11. COS updates the claim to the UPM with the gap payment amount. The UPM marks the gap only claim as complete. Alternatively COS informs the insurance staff of the new gap payment by the customer and the gap payment amount is manually entered by the staff at the Catch UI.
12. The UPM reimburses the veterinary practice the benefit amount, typically via bank transfer.
13. The UPM sends a benefit statement to the customer (email or post).

Now that a preferred embodiment of a computer-implemented method of managing an insurance claim has been described it will be apparent to those skilled in the art that it has the following advantages:
1. the method and associated computer system enable substantially real time submission and assessment of an insurance claim for payment of the remaining or gap amount at the time of attending the veterinary practice for the required treatment;
2. the method and system allow a veterinary practice with their existing software to communicate directly with the insurance provider without for example having to rely upon a client/browser application;
3. the method and system of the software platform in adopting an industry standard data model integrate with the veterinary practice and in particular the VPMS, typically using an industry standard data format;
4. the method and system are configured for integration with various insurance providers with the insurance integration component of the software platform being tailored for compatibility with the insurance provider or UPM;
5. the method and system enable relatively quick reimbursement of the veterinary practice of the benefit amount by the insurance provider following payment of the remaining or gap only amount by the policy owner;
6. the method and system significantly reduce the time and effort otherwise required by the policy owner in manually submitting an insurance claim together with supporting documents for reimbursement of the benefit amount payable by the insurance provider for the claim.

Those skilled in the art will appreciate that the invention as described herein is susceptible to variations and modification other than those specifically described. Although the invention as broadly described is directed to notification of the benefit amount, the method may also extend to notification of the remaining or gap amount derived from the benefit amount, typically by deducting the benefit amount from the invoiced amount. The workflows, routines or other functionality of the software platform may depart from the preferred embodiment provided it remains broadly within the scope of the broadest aspects of the invention. The standard data format of the claimed data ingested by the software platform may depart from the canonical model provided the VPMS is compatible with the vet hub API or associated claim workflow database. The retrieval of workflows or other data from either the claim workflow database or the insurance integration database may depart from the poll/respond or push models implemented by the API and COS components of the preferred software platform.

All such variations and modifications are to be considered within the scope of the present invention the nature of which is to be determined from the foregoing description.

1. A computer-implemented method of managing an insurance claim, said method comprising the steps of:
receiving claim data associated with an insurance claim made under an insurance policy of an insurance provider, said insurance claim being made in respect of treatment of an animal at a veterinary practice;
processing the claim data to provide a claim workflow derived from said claim data;
electronically submitting an integrated claim workflow to the insurance provider for assessment of the insurance claim under the insurance policy, the integrated claim workflow being derived from the claim workflow and provided in a format compatible for submission to the insurance provider;
receiving notification from the insurance provider of a benefit amount to be paid by the insurance provider under the insurance policy for said treatment;
electronically querying the insurance provider in relation to the benefit amount being payable for the treatment of the animal at the veterinary practice, said querying of the insurance provider involving periodic polling of the insurance provider in relation to the benefit amount;
electronically informing the veterinary practice of the benefit amount to be paid by the insurance provider to either the veterinary practice or a policy holder of the insurance policy.

2. A computer-implemented method as claimed in claim 1 wherein, in the event of a change in the status of the insurance claim, the step of receiving notification of the benefit amount also involves the insurance provider responding to the periodic polling with notification of the benefit amount.

3. A computer-implemented method as claimed in claim 1 also comprising the step of receiving notification of payment of a remaining amount from the policy holder or an associated individual to the veterinary practice for the treatment of the animal, the remaining amount calculated by deducting the benefit amount from an invoiced amount for said treatment.

4. A computer-implemented method as claimed in claim 3 wherein the notification of payment of the remaining amount is transmitted to the insurance provider prompting payment by the insurance provider of the benefit amount to the veterinary practice or the policy owner.

5. A computer-implemented method as claimed in claim 3 wherein the remaining amount is paid at the veterinary practice by the policy owner or the associated individual at the time of attending the veterinary practice for the treatment.

6. A computer-implemented method of managing an insurance claim, said method comprising the steps of:
receiving claim data associated with an insurance claim made under an insurance policy of an insurance provider, said insurance claim being made in respect of treatment of an animal at a veterinary practice;
processing the claim data to provide a claim workflow derived from said claim data;
electronically submitting an integrated claim workflow to the insurance provider for assessment of the insurance claim under the insurance policy, the integrated claim workflow being derived from the claim workflow and provided in a format compatible for submission to the insurance provider;
receiving notification from the insurance provider of a benefit amount to be paid by the insurance provider under the insurance policy for said treatment;
entering the notification of the benefit amount is into an insurance integration database via an associated insurance user interface;
storing the notification of the benefit amount received from the insurance provider in the insurance integration database from which the integrated claim workflow is electronically submitted;
electronically informing the veterinary practice of the benefit amount to be paid by the insurance provider to either the veterinary practice or a policy holder of the insurance policy.

7. A computer-implemented method of managing an insurance claim, said method comprising the steps of:
receiving claim data associated with an insurance claim made under an insurance policy of an insurance provider, said insurance claim being made in respect of treatment of an animal at a veterinary practice;
processing the claim data to provide a claim workflow derived from said claim data;
electronically submitting an integrated claim workflow to the insurance provider for assessment of the insurance claim under the insurance policy, the integrated claim workflow being derived from the claim workflow and provided in a format compatible for submission to the insurance provider;
receiving notification from the insurance provider of a benefit amount to be paid by the insurance provider under the insurance policy for said treatment;
storing the notification of the benefit amount received from the insurance provider in an insurance integration database from which the integrated claim workflow is electronically submitted;
sending the notification of the benefit amount from the insurance integration database to a claim workflow database associated with the claim workflow electronically informing the veterinary practice of the benefit amount to be paid by the insurance provider to either the veterinary practice or a policy holder of the insurance policy.

8. A computer-implemented method as claimed in claim 7 wherein the notification of the benefit amount is converted to a compatible data format capable of being read by the veterinary practice.

9. A computer-implemented method as claimed in claim 8 wherein the compatible data format is based on a canonical data model.

10. A computer-implemented method as claimed in claim 8 wherein the notification of the benefit amount in the compatible data format is stored in the claim workflow database.

11. A computer-implemented method as claimed in claim 8 wherein the step of electronically informing the veterinary practice of the benefit amount involves prompted delivery of the notification of the benefit amount to the veterinary practice in the compatible data format.

12. A computer-implemented method as claimed in claim 8 wherein the benefit amount in the compatible data format is delivered to the veterinary practice by calling the veterinary practice for pushing of the benefit amount to said practice.

13. A computer-implemented method as claimed in claim 11 further comprising the method still further comprises the step of sending the notification of the benefit amount from the insurance integration database to a claim workflow database associated with the claim workflow.

14. A computer-implemented method as claimed in claim 13 wherein the notification of the benefit amount is converted to a compatible data format capable of being read by the veterinary practice.

15. A computer-implemented method as claimed in claim 14 wherein the compatible data format is based on a canonical data model.

16. A computer-implemented method as claimed in claim 14 wherein the notification of the benefit amount in the compatible data format is stored in the claim workflow database.

17. A computer-implemented method as claimed in claim 14 (when dependent on claim 9) wherein the step of electronically informing the veterinary practice of the benefit amount involves prompted delivery of the notification of the benefit amount to the veterinary practice in the compatible data format in response to periodic polling from the veterinary practice.

18. A computer-implemented method as claimed in claim 14 wherein the benefit amount in the compatible data format is delivered to the veterinary practice by calling the veterinary practice for pushing of the benefit amount to said practice.

19. A computer system for managing an animal insurance claim, said system comprising:
a storage component including a claim workflow database for storing a claim workflow derived from claim data associated with an insurance claim for treatment of an animal;
a submitting component arranged to communicate with the storage component, said submitting component being configured to electronically submit an integrated claim workflow to an insurance provider for assessment of the insurance claim under an insurance policy pertaining to the animal, the integrated claim workflow being derived from the claim workflow and provided in a format compatible for submission to the insurance provider;
a notification component configured to receive a notification from the insurance provider of a benefit amount to be paid by the insurance provider under the insurance policy for said treatment;
an informing component arranged to communicate with the notification component, said informing component being configured to electronically inform the veterinary practice of the benefit amount to be paid by the insurance provider to either the veterinary practice or a policy owner of the insurance policy.

20. A computer system for managing an animal insurance claim, said system comprising:
a processor;
a memory device which stores a plurality of instructions which when executed by the processor cause the processor to:
receive claim data associated with an insurance claim made under an insurance policy of an insurance provider, said insurance claim being made in respect of treatment of an animal at a veterinary practice;
process the claim data to provide a claim workflow derived from said claim data;
electronically submit an integrated claim workflow to the insurance provider for assessment of the insurance claim under the insurance policy, the integrated claim workflow being derived from the claim workflow and provided in a format compatible for submission to the insurance provider;
receive notification from the insurance provider of a benefit amount to be paid by the insurance provider under the insurance policy for said treatment;
electronically inform the veterinary practice of the benefit amount to be paid by the insurance provider to either the veterinary practice or a policy owner of the insurance policy.
